(19) United States
(12) Patent Application Publication
(10) Pub. No.: US 2002/0030958 A1
(43) Pub. Date: Mar. 14, 2002

(54) Protection against fault situations in a telecommunications network

(75) Inventors: Gosta Baarman, Siuntio (FI); Kai Kiiskila, Espoo (FI); Veikko Virpioja, Kirkkonummi (FI)

Correspondence Address: Michael B. Lasky, Altera Law Group, LLC, Suite 100, 6500 City West Parkway, Minneapolis, MN, 55344-7701, US

(73) Assignee: Nokia Networks Oy, Espoo (FI)

(21) Appl. No.: 09/953,392

(22) Filed: Sep. 12, 2001

(30) Foreign Application Priority Data
Sep. 13, 2000 (FI) 20002021

(51) Int. Cl. H02H 9/06

(52) U.S. Cl. 361/119

(57) ABSTRACT

This invention relates to the protection against over-voltage situations in a telecommunications network. Especially, the invention relates to fault situations that are generated by a power distribution network. The idea of the invention is to protect the telecommunication equipment against any overvoltage caused by an external source. The invention uses a detector core around cables through which a common mode fault current goes. The subscriber line cables or the power & ground cables form a primary coil in a transformer. The transformer's secondary coil forms an output current, preferably for converting equipment that converts the fault current information into a suitable form for operational devices that perform a desired protection action.

### FIELD OF THE INVENTION

This invention relates to the protection against over voltage situations in a telecommunications network. Especially, the invention relates to fault situations that are generated by a power distribution network.

### BACKGROUND OF THE INVENTION

Telecommunications networks are normally protected against lightning and other abnormal actions that can cause damaging over-voltages and over-currents. An over-voltage (or over-current) can get into a circuit through a galvanic connection, inductively or capacitively. Protection devices, such as gas-discharge tubes, varistors and discharge gaps, connect over-voltages and over-currents into the ground.

FIG. 1 shows an typical example of a situation where a 20 kV or higher voltage power distribution line (1) crosses above telecommunications network lines (5) in a suburban area. When a bolt of lightning hits the power distribution line, protection devices (2) on the line connect the lightning current to the ground. However, the protection devices do not switch off immediately after the bolt of lightning, but they are conducting up to a few seconds, depending on power line structures. During this time period, a generator (4) (or a transformer), which supplies power into the network, causes a fault current (3) into the ground through the protection devices, which are on the power line. The fault current causes an increase of a ground potential near the place where the fault current goes into the ground.

If there exists a pole of a telecommunications network nearby the fault of the powerline and where a protection device of the telecommunications network is located, it is possible that the fault current of the power line causes a fault current in the telecommunications line. In FIG. 1, the increased ground potential switches protections devices (6) on in the nearby power line and in a telecommunications station (7) containing access equipment (8) for the telecommunications lines (5). Due to the protection devices being on (6), and different ground potentials in the telecommunications stations and the position of the telecommunications network pole nearby the powerline, a circuit loop, where a common mode fault current (IC) goes, is formed. The form of the common mode fault current is 45 Hz . . . 60 Hz sine distorted by the action of the protective devices. A similar common mode fault current (9) may happen in a subscriber's premises (10) if a terminal (11) is grounded.

At present, protection devices used in telecommunications networks do not work properly when there exists a common mode fault current as described above. The common mode fault current causes repetitive on and off switchings in protection devices. The switching actions usually contain delays based on the character of the protection devices. The repetitive switchings and delays cause stress and disruptions in telecommunications devices. The goal of the invention is to alleviate these drawbacks on the known solutions. This is achieved in a way described in the claims.

### SUMMARY OF THE INVENTION

The idea of the invention is to protect the telecommunication equipment against any over-voltage (or over-current) caused by an external source (i.e. not from a internal source, such as telecommunication equipment or a subscriber terminal).

The invention uses a detector core around cables through which a common mode fault current goes. It is practical that the subscriber line cables or the power & ground cables form a primary coil in a transformer. The transformer's secondary coil forms an output current, preferably for converting equipment that converts the fault current information into a suitable form for operational devices that perform a desired protection action. There may be solutions that do not need the converting equipment.

A detector device, i.e. the transformer, can handle several pair cables at the same time. Due to the fact that the common mode fault current usually goes through the ground, an especially good place to situate the detector device is around the ground cable and power feeding cables. The detector device can be also placed around a single pair cable.

The operational devices can be, for example, switches that connect cables to the ground reliably, or switches that isolate the telecommunications equipment from the cables.

### BRIEF DESCRIPTION OF THE DRAWINGS

In the following the invention is described in more detail by means of FIGS. 1-11 in the attached drawings where.

FIG. 1 illustrates an example of a situation when a fault on a power supply line causes a common mode fault current on a telecommunications line,

FIG. 2 illustrates an example of a known over-voltage protection device,

FIG. 3 illustrates an example of a voltage-current diagram of a a known over-voltage protection device,

FIG. 4 illustrates an example of a sine waveform over-voltage,

FIG. 5 illustrates an example of detector core around a line,

FIG. 6 illustrates an example of places where a detector device can be situated in a telecommunications station,

FIG. 7 illustrates an example of places where a detector device can be situated in a subscriber's premise,

FIG. 8 illustrates an example of the invention using blocks,

FIG. 9 illustrates an example of elements of the invention at the circuit level,

FIG. 10 illustrates an example of a protection switch.

FIG. 11 illustrates an example of places where a protection device can be situated.

### DETAILED DESCRIPTION OF THE INVENTION

FIG. 2 shows an example of a typical protection device against over-voltages and over-currents. Between the pair cable lines (16, 17) and the ground potential (18) there exist gas-discharge tubes (12) and a semiconductor protection device (13). PTC resistors (14), situated on the subscriber lines, separate the connection points of the tubes and semiconductor protection device on the pair cable lines. The semiconductor protection device is used due to the delay of the gas-discharge tubes to achieve a faster protection. A common mode fault current (IC) discharges to the ground through the gas-discharge tubes and the semiconductor protection device, but usually, due to the delay, a part (IU) of the common mode fault current passes into telecommunications equipment (15).

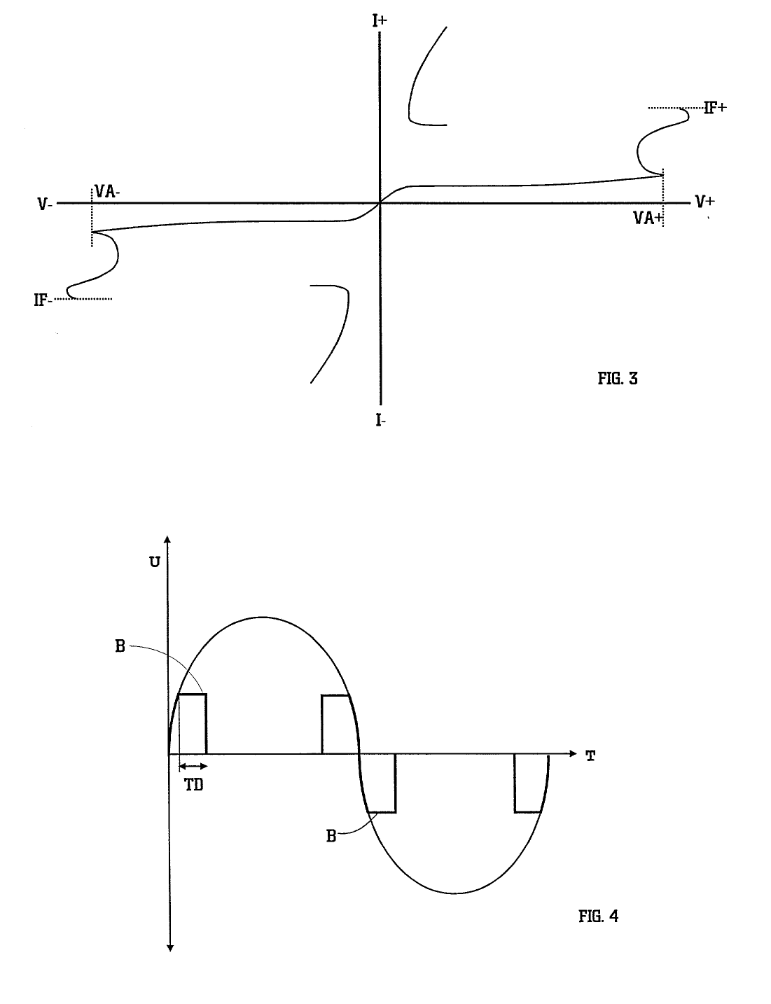

An example of typical voltage-current characteristics of a semiconductor protection device is showed in FIG. 3. When an over-voltage achieves a certain voltage value (VA), the protection device starts to conduct current through it. The final breakdown happens after the current has raised to a value (IF), where the actual protection switching happens. A protection device cuts both negative and positive over-voltages.

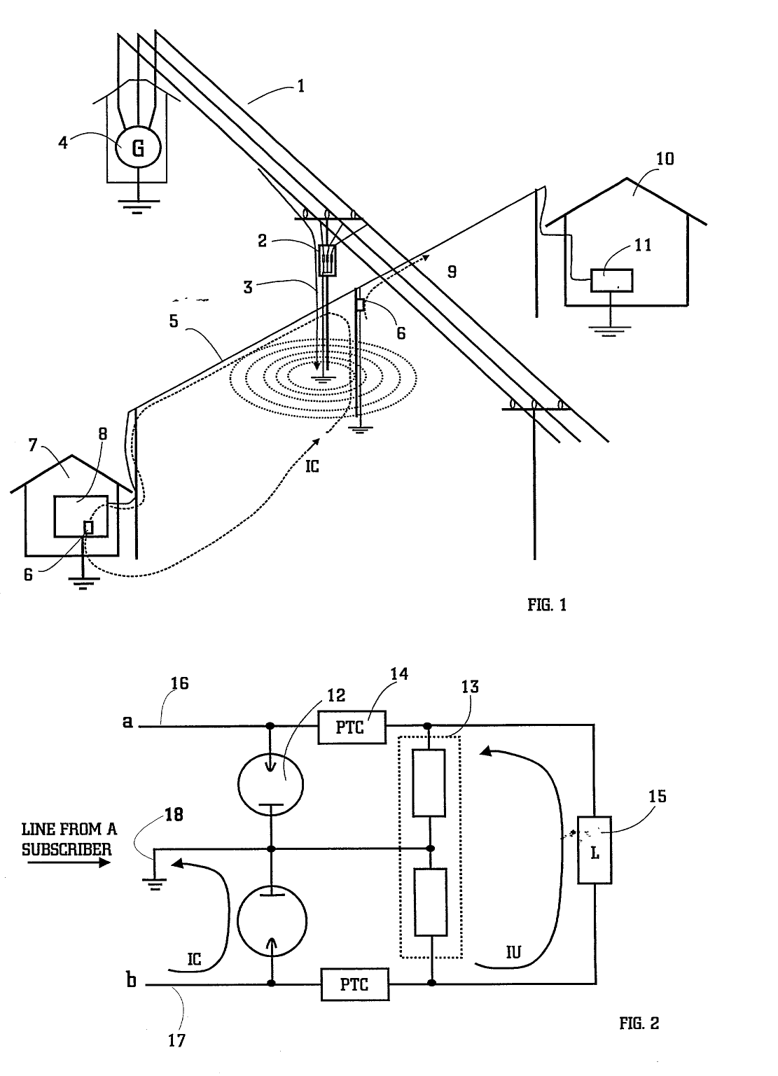

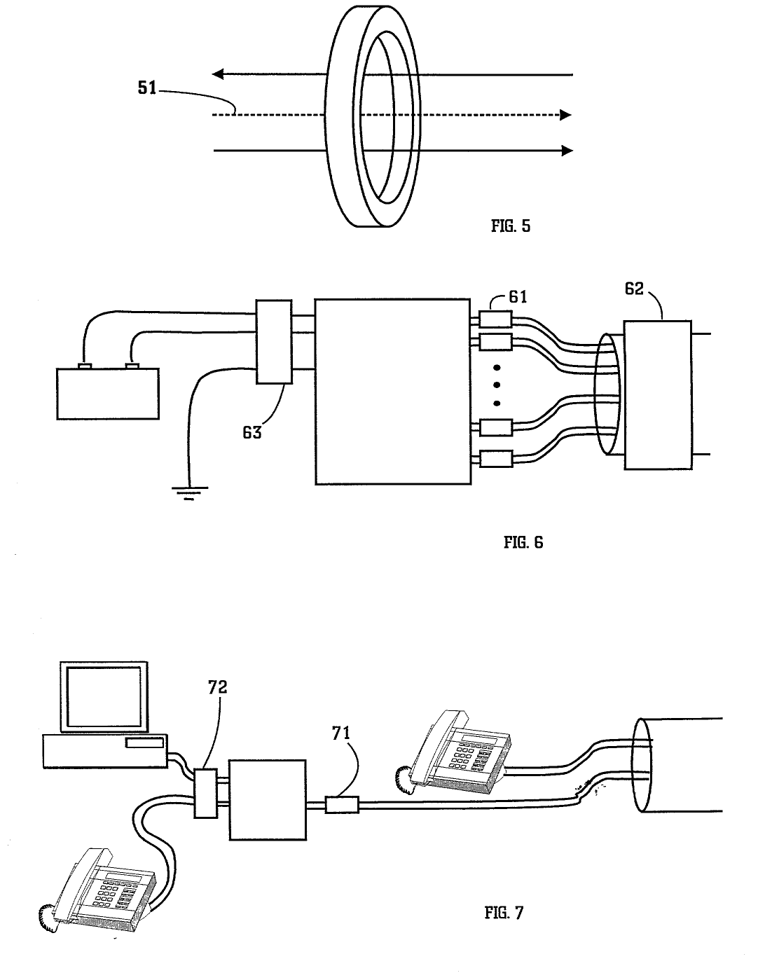

Let's look at a fault situation according to FIG. 1, and assume that the voltage of a common mode fault current of 50 Hz sine is much higher than a voltage in use in a telecommunications line. Due to these assumptions, it is possible to approximate the over-voltage in the telecommunications line to be the voltage generated by the common mode fault current as described in FIG. 4. When a common mode over-voltage achieves a voltage value high enough (FIG. 3, VA), a protection device starts to conduct current through it. The final breakdown (B) happens after the current has raised to a value (IF) causing delay TD. However, the difference between the voltages of the starting and breakdown is relatively small, so the voltage (FIG. 4, B) during the delay can be approximated to be constant, as FIG. 4 shows. The voltage that appears in the telecommunications line is marked in thick lines. The voltage from the start of the cycle to the end of the delay (TD) forms an approximately rectangular part which represents the energy bypassing the semiconductor protection device. The common mode voltage and current when the semiconductor over-voltage protection device is inactive, causes unnecessary stress in telecommunication equipment and may cause disturbances.

Commonly used over voltage devices first notice the rise of a voltage level and after the current rises, they may react to it. There also are protection devices which react on the differential current. The invention notices a common mode fault current caused by an external fault voltage. The arrangement according to the invention uses fault current detectors. FIG. 5 shows an example of the princple of a fault current detector. The detector is a transformer core that surrounds a pair cable line. In a normal situation, the sum of the currents, which go through the transformer windings, is zero, but when a common mode fault current (51) occurs in one of the cables or both, an unbalance occurs. As this unbalance occurs, a current flows in the secondary winding. The sum of the fault currents can be either positive or negative. The secondary current in the secondary winding can be connected to detecting circuits that can be connected to protection switches ing circuits that can be connected to protection switches or measurement devices. If more detailed measurement information is needed, it is possible to use more than one secondary winding.

FIG. 6 shows how detector devices can practically be assembled in telecommunication sites, and FIG. 7 shows how the detector device can be placed (71, 72,) in a subscriber's premises. Present over voltage devices are related to a single line. The invention allows that a single detector device can handle several lines at the same time. The detector core can be placed to a single line (FIG. 6, 61) or handling all lines (62). It is also possible to place the detector device in a very efficient way around the ground and power supply cables (63) in a telecommunication site.

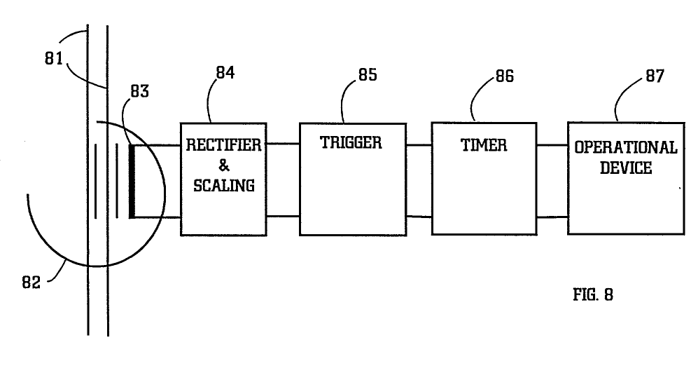

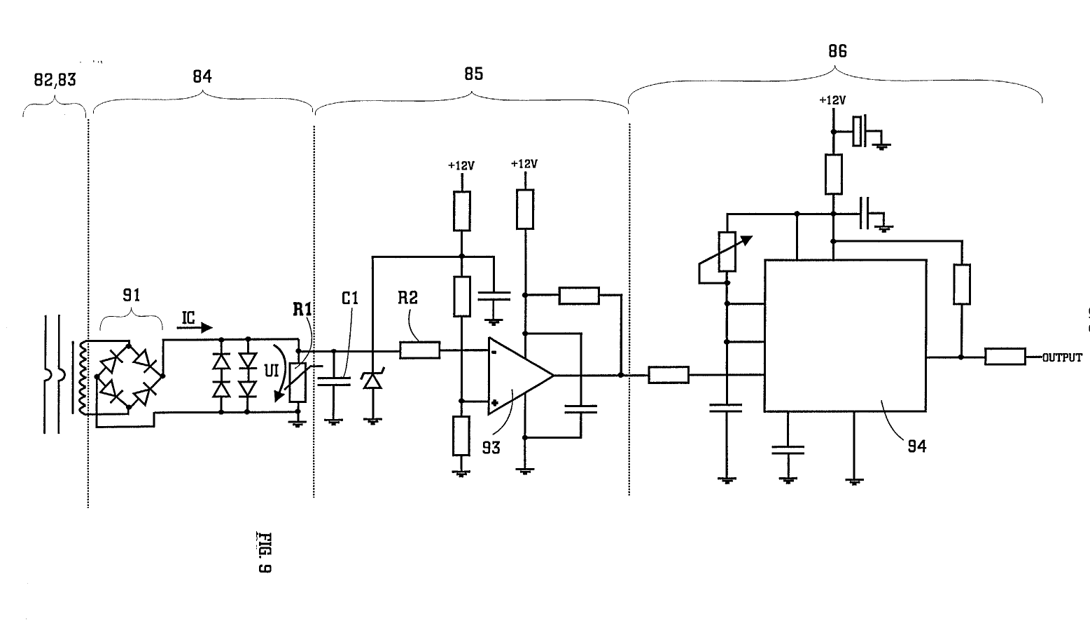

FIG. 8 shows an example of an arrangement according to the invention in a block diagram. A fault current transformer core (82) surrounds cables (81) in which a common mode fault current flows. The fault current induces a current in the secondary coil (83) which is connected to a rectifier (84). The rectified current is converted to voltage by a scaling resistor RI (FIG. 9). This voltage is connected to a trigger circuit (85), which forms a trigger pulse for a timer (86). When the timer gets the trigger pulse, it forms an output pulse with a suitable duration. The output pulse can be used for necessary operations (87), such as protection switching.

FIG. 9 shows an example of how the blocks of FIG. 8 can be constructed at the circuit level. The detector core (82) around the cables forms a fault current transformer as described above. The rectifier (84) contains a diode bridge (91) for making the conversion, the resistor RI for converting the current information (IC) to the voltage information (Ul). The rectifier block also contains diodes for clipping and protection purposes, before the voltage information is connected to the trigger (85).

The trigger consists of a comparator (93) in FIG. 9. The signal is taken trough a bias resistor R2 to the negative input of the comparator. A reference voltage level for the positive input of the comparator is formed by a circuit of resistors, a zener and a capacitor, getting a voltage feed from a +12 V source. When the trigger receives the voltage information (UI) from the rectifier and voltage scaling resistor, the signal based on the voltage information changes the voltage level in the negative input of the comparator, which forms a trigger pulse to its output. The output is connected to the timer (86).

The timer consists of a timer circuit (94) and necessary components connected to the timer circuit. When the timer gets the trigger pulse, it forms a pulse to the output of the timer. The duration of the output pulse is chosen to be suitable concerning its use in an operational device, such as protection switches.

As it can be noticed, the arrangement according to FIGS. 8 and 9 contains at least three phases: measurement (82,83), performing necessary conversions (84, 85, 86) of measurement information, and performing necessary operations (87). The converting phase can be divided into sub-phases, such as rectification, voltage conversion and scaling, performing a trigger pulse, and pulse shaping in a timer. The operation phase includes necessary operations, such as protection switchings.

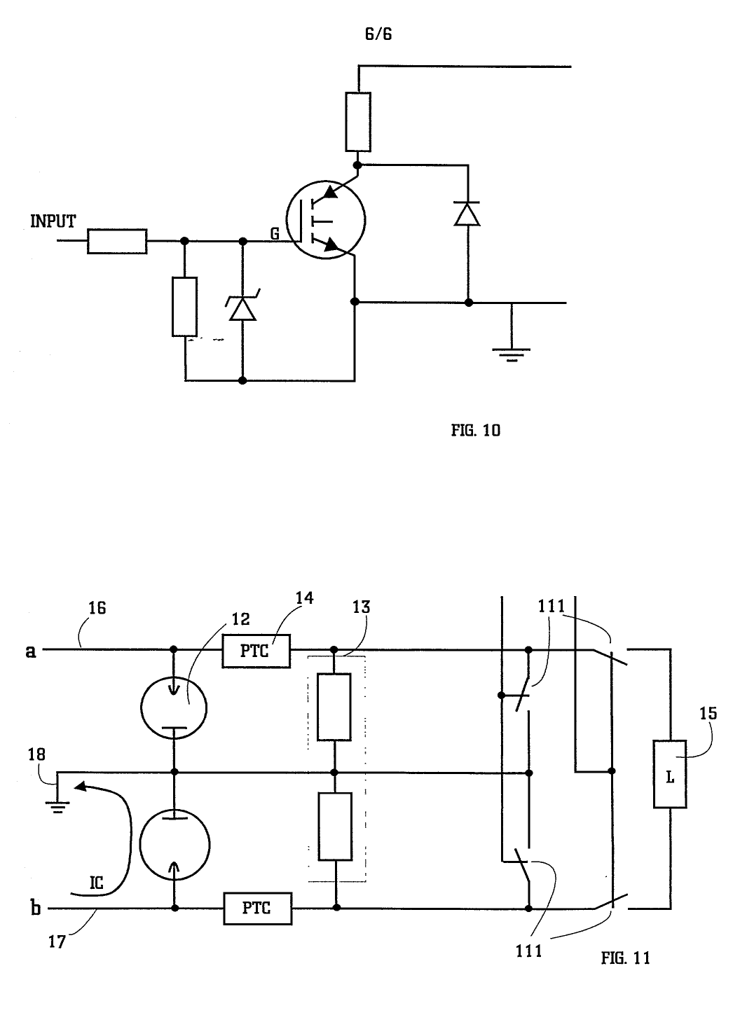

FIG. 10 shows an example of a protection switch in a circuit diagram. When a pulse generated by a common mode fault current comes to the input of the protection switch, it changes a voltage level in the gate (G) of a FET opening the main circuit of the switch, by letting a current go through the FET.

FIG. 11 shows an example how protection switches (111) can be situated. If the switches are placed in parallel with the original high-voltage protectors, between the subscriber lines and ground, the switches can connect the line cables to the ground when a common mode current occurs. The difference between the original high-voltage protector's ground connection and the switch's ground connection, is that the switch sustains the ground connection longer than the original high-voltage protector. As described before, the original high-voltage protector's ground connection operates repeatedly at each AC cycle, but the protector device's (ground switches) ground connection holds until the common mode fault current decays.

If the protection switches are supposed to isolate telecommunications devices from the subscriber line cables, they break the connection between the cables and the devices. It should be noted that the current needs a commutating route. The isolation switches and grounding switches can also be used together if protection requirements are very high.

The invention offers protection against all harmful AC-disturbances, which occur as a common mode current. Usually traditional high-voltage protectors cause a common mode fault current to enter into telecommunication equipment, causing extra stress and disruptions. The invention can also be used for measurement and registration purposes. It is possible to measure and register an analog common mode current for closer examination. Furthermore an event counter can be connected to the system.

It is possible to implement the invention in many ways, not only in the before-mentioned ways. Due to that, it is evident that the invention can be used in the scope of the inventive idea.

1. A protection arrangement against harmful voltages and currents in a telecommunications network, which contains several pair cable lines and telecommunications equipment, characterized in that the arrangement includes
at least one measurement device for measuring a common mode fault current, which goes through, at least one cable,
at least one operational device, responsive to the measurement device, for performing a desired protection action.

2. An arrangement according to claim 1, characterized in that the arrangement also contains converting equipment for converting the measurement information from the measurement device suitable for the operational device.

3. An arrangement according to claim 1 or 2, characterized in that the measurement device contains a transformer where a primary coil is formed by the cables going through a transformer core and a secondary coil forms a suitable current value from the current unbalance in the primary coil.

4. An arrangement according to claim 1 or 2, characterized in that the measurement device contains a transformer where a primary coil is formed by the cables going through a transformer core and several secondary coils forms suitable current values from the current unbalance in the primary coil.

5. An arrangement according to claim 1 or 2, characterized in that the operational device is a switch that connects at least one cable to the ground.

6. An arrangement according to claim 1 or 2, characterized in that the operational device is a switch that isolates at least one cable from the telecommunications equipment.

7. An arrangement according to claim 1 or 2, characterized in that the operational device is a switch that activates an external protector device.

8. An arrangement according to claim 1 or 2, characterized in that the operational device is a switch that disconnects the telecommunications equipment and at least one power supply.

9. An arrangement according to claim 1 or 2, characterized in that the operational device is a switch that connects at least one power supply to the ground.

10. An arrangement according to claim 2, characterized in that the converting equipment contains a rectifier, a trigger and a timer.

11. A method for protecting telecommunication equipment against harmful voltages and currents in a telecommunications network, which contains one or several pair cable lines and telecommunications equipment, characterized in that the method contains steps of
measuring a common mode fault current, which goes through at least one cable,
in response to the measuring, performing a desired protection action.

12. A method according to claim 11, characterized in that the method also contains an intermediating step between the measurement and protection action steps, the intermediating step performing necessary convertings of the measurement result to a suitable form for performing the desired protection action.

13. A method according to claim 11, characterized in that the desired protection action is a switching action for connecting at least one cable to the ground.

14. A method according to claim 11, characterized in that the desired protection action is a switching action for isolating at least one cable from the telecommunications equipment.

15. A method according to claim 11, characterized in that the desired protection action is a switching action for activating an external device.

16. A method according to claim 11, characterized in that the desired protection action is a switching action for disconnecting the telecommunications equipment and at least one power supply.

17. A method according to claim 11, characterized in that the desired protection action is a switching action for connecting at least one power supply to the ground.

18. A method according to claim 10, characterized in that the intermediating step includes the steps of
converting AC current from the measurement device to DC current,
generating a trigger pulse on the basis of the converted measuring and,
generating a pulse with a suitable duration for the desired protection action in response to the trigger pulse.
